(19) United States
(12) Patent Application Publication
(10) Pub. No.: US 2023/0239420 A1
(43) Pub. Date: Jul. 27, 2023

(54) CONTROL OF COLORANTS AND TREATMENTS FOR PRINTING

(71) Applicant: Hewlett-Packard Development Company, L.P., Spring, TX (US)

(72) Inventors: Peter MOROVIC, Sant Cugat del Valles (ES); Jan MOROVIC, London (GB); Joan VIDAL FORTIA, Sant Cugat del Valles (ES); Xavier FARINA VARGAS, Sant Cugat del Valles (ES); Sergio ETCHEBEHERE JUAN, Sant Cugat del Valles (ES); Hector GOMEZ MINANO, Sant Cugat del Valles (ES)

(73) Assignee: Hewlett-Packard Development Company, L.P., Spring, TX (US)

(21) Appl. No.: 17/999,422

(22) PCT Filed: May 22, 2020
(86) PCT No.: PCT/US2020/034307

§ 371 Date: Nov. 21, 2022

(51) Int. Cl. H04N 1/60

(52) U.S. Cl. CPC H04N 1/6016; H04N 1/6041; H04N 1/6044; H04N 1/6008

(57) ABSTRACT

Certain examples described herein relate to the control of colorants and treatments for printing. In certain examples image data, a colorant color mapping and one or more treatment color mappings is obtained. The colorant color mapping may be used to map the image data to colorant application values. The one or more treatment color mappings may be used to map the image data to treatment application values. The colorant application values and treatment application values may be used to generate discrete print control instructions to apply the set of colorants and set of treatments to a printing substrate.

### BACKGROUND

Colors defined in an input color space, for example a Red, Green, Blue (RGB) color space, may be converted to colors defined in an output color space, for example Cyan, Magenta, Yellow, BlacK (CMYK). This may be achieved using color mappings where the colors of the input color space are mapped to colors of the output color space. Converting from one color space to another color space may be used to generate data which can be used for printing applications. For example, the CMYK output color space may be used for printing using a printer having a CMYK colorant set. Colors may be defined in a color space using multidimensional application values which may specify proportions or amounts of each colorant channel. The application values can then be used to form a set of instructions to be used by the printer to deposit the colorants on to a printing substrate.

In certain cases, the printing of an image may also include the use of pre-treatments and post-treatments. Pre-treatments may be applied to a printing substrate before deposit of colorants and post-treatments may be applied after deposit of colorants. These may be used to enhance image quality or provide particular print properties, such as a shine or gloss. Typically, pre- and post-treatments are applied as constant amounts. For example, treatments can be deposited as a fixed percentage of a total amount of printing material that is deposited on the printing substrate.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a flow chart illustrating a method of generating discrete print instructions to apply a set of colorants and set of treatments to a printing substrate according to examples;

FIG. 2 is a schematic diagram illustrating the generation of print control instructions using a colorant look-up table, a pre-treatment look-up table and a post-treatment look-up table according to examples;

FIG. 3 is a flow chart illustrating a method of adjusting a colorant look-up table and a post-treatment look-up table according to examples;

FIG. 4 is a table illustrating the form of input and output nodes associated with colorants, pre-treatments and post-treatments according to examples;

FIG. 5 is a table illustrating a first example color mapping for a first node of image data for each of colorants, pre-treatments and post-treatments according to examples;

FIG. 6 is a table illustrating a second example color mapping for a second node of image for each of colorants, pre-treatments and post-treatments according to examples;

FIG. 7 is a schematic diagram of a printing system according to examples.

### DETAILED DESCRIPTION

Certain examples described herein relate to printing systems. In particular, certain examples relate to printing systems that apply a set of colorants and a set of one or more treatments. For example, the colorants may be CMYK-based inks and the one or more treatments may comprise pre- or post-treatments such as undercoats, glosses and varnishes. In certain examples, the set of colorants and the one or more treatments are controlled independently in the printing system. This independent control may comprise utilizing independent color mappings to output application values associated with each of the set of colorants and the one or more treatments. In certain variations, the color mappings associated with the set of colorants and the one or more treatments may be adjusted as a function of each other and/or other print characteristics. Through these examples, interactions between the set of colorants, the one or more treatments and the printing substrate may be controlled in an efficient and tractable manner. Through a more direct and targeted use of the set of colorants and the one or more treatments, e.g. in response to their interaction characteristics, print qualities such as color, coalescence and durability may be improved.

In examples described herein, an input color space may be defined as a multi-dimensional space with a point in the multi-dimensional space representing a color value and dimensions of the space representing variables within the color model. For example, in a Red, Green, Blue (RGB) input color space, an additive color model defines three variables representing different quantities of red, green and blue light. In a digital model, values for these quantities may be defined with reference to a quantized set of values. For example, a color defined using an 8-bit RGB model may have three values stored in a memory, wherein each variable may be assigned a value between 0 and 255. The input color space may be modelled as a plurality of nodes where each node is comprised of the three RGB values. Other input color spaces include a Cyan, Magenta, Yellow and BlacK (CMYK) color space, in which four variables are used in a subtractive color model to represent different quantities of colorant.

In a printing system, image data such as digital image data may be received which is defined within an input color space. The printing system may then represent the digital image data in an application color space which is selected based on available printing materials in the printing system and the possible application states of those printing materials. For example, a printing system may include a set of colorants—Cyan, Magenta, Yellow and Black—and so the application color space represents application of the set of CMYK colorants to a printing substrate. The term “application” is used as a printing system may be limited in the manner in which printing materials are applied to a printing substrate. For example, an ink-jet printing system may be able to output discrete drop sizes of ink onto a sheet of paper; for a particular addressable area of the paper (e.g. a print resolution “pixel”), the printing system may be able to deposit one or more drops of ink from one or more of the set of colorants. Hence, an application color space may be defined in terms of different possible ink amounts and different printing material combinations that are possible with the printing system. Examples described herein may be said to relate to an application color space as values in the application space determine color properties of a printed output.

Certain examples described herein extend the concept of an application color space for colorants (such as CMYK-based 4, 6 or 8 ink configurations) to treatments. Treatments as described herein may comprise printing materials that are deposited before and/or after a set of colorants in order to complete a print job. For example, a pre-treatment such as an undercoat may prepare a printing substrate for the application of the set of colorants; a post-treatment such as a gloss or varnish may enhance the appearance of a printed output and/or provide protection from wear or the environment. In comparative examples, these may be applied in constant amounts across a printing substrate, e.g. a particular quantity of undercoat may be applied evenly across a print area of a printing substrate and a particular quantity of gloss may be applied evenly over the top of a print output. In the present case, use may be made of advanced techniques for the application of treatments, e.g. multi-drop print heads that allow for a fine print resolution deposit may be adapted to apply treatments in a similar manner to colorants. As such, a treatment may be deposited in addressable areas of the print output (these print resolution “treatment pixels” may be the same resolution as the print resolution of the applied colorants or a different resolution, such as a coarser resolution). An application space for a treatment may thus be based on depositable or controllable quantities of a treatment that may be applied to a particular addressable area of print output.

In examples, the plurality of nodes of the input color space may be mapped to associated nodes of the application space through the use of color mapping. The color mapping may be a data structure which stores pre-computed mappings from a color defined in the input color space to a set of application values defined in the application space. It should be noted that the term “color” in “color mapping” is used broadly—the input to the mapping is a “color” and so the mapping is a “color mapping” in that sense; however, the outputs of the color mapping in the application space need not be colored or relate to colorants per se, e.g. a treatment may be clear but application of the treatment may affect the appearance of colorants deposited on top and/or below the treatment. The term “color mapping” should thus be interpreted as meaning a form of appearance mapping where the color mappings for the treatments affect the color of the printed output. In one case, the color mapping may be pre-determined. A pre-determined mapping may be stored in a look-up table (LUT) that maps the nodes of the input color space to the nodes of the application space. Pre-calculation of the color mappings may be based on simulations of the printing system and its associated characteristics and/or test outputs, such as color patches that are measured with a colorimeter or spectrophotometer.

In one case, an application space may be defined in terms of a plurality of Neugebauer Primaries (NP). A NP may be considered to be one particular discrete output state for the application of a set of printing materials. For example, a set of colorants may be applied in various available combinations (including overprints), or not applied at all; in this case, each of the available combinations and the “blank” state may be considered as NPs. In certain cases, printing fluids may be applied in different discrete amounts, for example, a colorant or treatment may be applied to a printing substrate as one, two or three drops of a fixed size. In this case, the NPs may also take into account the different sizes of application or deposit. For example, a single treatment printing fluid having a possibility to overprint with up to three drops may have four different NPs—[N, D, DD, DDD], where N represents no drops and D represents a drop of a fixed size (i.e. DDD=three drops).

In general, a printing system may be configured to output a single NP for every print resolution pixel. For example, in the four-state treatment space described above, only one of these states is selectable for a given output area of printing substrate. However, the image data received for a print job may have a large range of possible values for each dimension in the input color space (e.g. an 8-bit RGB input has 256 possible values for each of the R, G and B dimensions). This large range of values is referred to as continuous tone (or “contone”) data. In order to convert from a contone input to discrete print instructions for a print output, a printing system may utilize a halftoning process. To provide an appearance similar to a contone image, a printing system may use halftoning to reproduce image data in the application space using a series of shapes such as dots. This enables the printing system to approximate contone image data using a discrete number of printing material states. For example, in the case of the printing materials comprising fluids, the printing system may approximate contone image data by using a discrete number of printer fluid drops. The result of the halftoning process may comprise a color-separated halftone comprising a halftone plane corresponding to each colorant and/or treatment available to the printing system. Each halftone plane (e.g. for each colorant and/or treatment) may have pixels with a limited number of possible values representing the output states for the particular printing material (e.g. each pixel may indicate a number of drops of the printing material—with single drop printers having binary values). The output of any particular printing system is dependent on the characteristics of the particular color halftone processing pipeline that is used by the printing system.

In certain examples, an application color space is defined as an area coverage space. In this case, a vector in the application color space may represent a set of probabilities for available NPs. Such an application space may be referred to as a Neugebauer Primary area coverage (NPac) application space. A value or point within an NPac space may be presented in the form of an NPac vector, where each element of the vector represents a different NP as described above, and the vector is normalized such that all the elements sum to unity (i.e. each element value reflects a probability of the state or NP associated with that element). An NPac vector for one or more print areas may form the input to a halftoning process, where the halftoning process may be thought of as a way to sample the probability vector to select one particular state (e.g. generate a one-hot output). Halftoning as applied to a set of NPac vectors may thus determine a spatial distribution to the NPs according to the probability distribution specified in the NPac vectors. For example, a suitable halftoning method includes the use of halftone matrix-selector-based techniques such as PARAWACS (Parallel Random Area Weighted Area Coverage Selection). An example of a printing system that uses area coverage representations for halftone generation is a Halftone Area Neugebauer Separation (HANS) pipeline.

Given the above, a printing system may be considered to apply a printing pipeline to convert image data in an input color space into application values for a set of available print materials. This may be a HANS pipeline. In a first operation of the pipeline, image data is received that is defined within an input color space. In a second operation of the pipeline, the image data in the input color space is mapped to an application space comprising application values. This may be considered a color mapping operation. In examples, the application space is an NPac space where application values are represented as an NPac vector. The image data in the input color space may thus be mapped to a corresponding set of NPac data in a NPac space. In this case, the application values may be considered probabilistic application values, as the NPac vector represents a probability vector. In a third operation of the pipeline, the application values are halftoned to output discrete print control instructions. The halftoning may use a halftone matrix, which serves as a selector or sampler for the NPac vectors. In the third operation, application values are used to generate discrete print control instructions which are used by the printing system to deposit printing materials on a printing substrate. In certain examples described below, this printing pipeline is applied to both colorants and treatments to improve a printing process, e.g. to improve printing quality or to optimize printing material use.

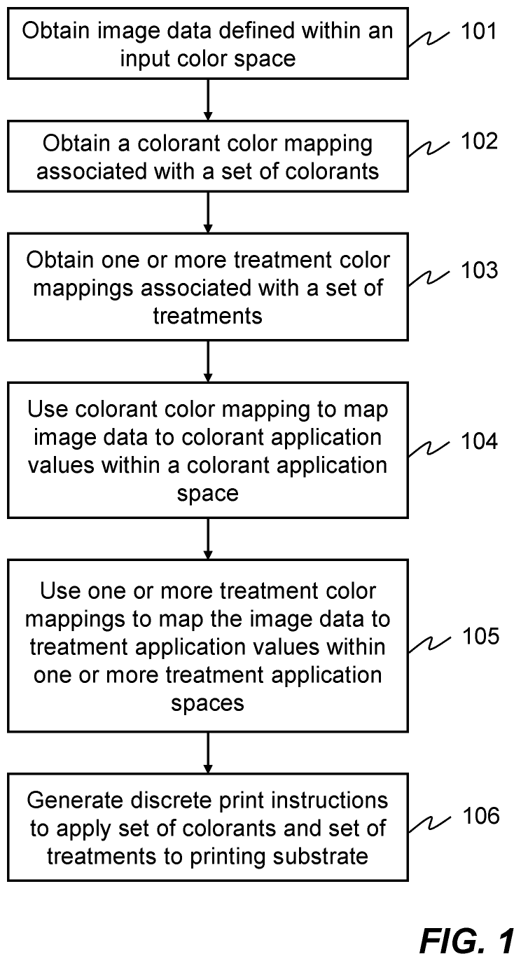

FIG. 1 is a flow chart illustrating a method of generating discrete print instructions to apply a set of colorants and a set of treatments to a printing substrate according to examples. In examples, the method is utilized by a printing system. The printing system may be an N-dimensional printing system, including two and three-dimensional printing systems. The printing system may comprise deposit mechanisms for the set of colorants and the set of treatments, such as print heads or other application mechanisms. These may form part of a shared aspect of the printing system, or may form different sections of a printing press (e.g. there may be physical sections of the printing press to apply the set of treatments and physical sections of the printing press to apply the set of colorants). The set of treatments may comprise one or more separate treatments, such as one or more pre-treatments and one or more post-treatments.

At block 101, image data defined within an input color space is obtained. The image data may be a two-dimensional picture, a defined three-dimensional structure or a biological structure. The image data may be received from an imaging interface of the printing system such as a print driver for a computing device and/or a digital front end for a printing press. In certain cases, the image data may be received from a computing device communicatively coupled to the printing system. The image data is defined within an input color space. The input color space may be one of a variety of color spaces, including RGB-based or CMYK-based color spaces and device-independent color spaces such as Commission Internationale de L'éclairage (CIE) LAB or XYZ color space. For ease of explanation, an example is presented wherein the input color space is a digital contone CMYK input color space. In this case, each pixel of image data may be defined using four 8-bit CMYK values.

Returning to FIG. 1, at step 102, a colorant color mapping associated with the set of colorants is obtained. The term “colorant” is used herein to refer to a printing material that is used to modify a color appearance of a printing substrate. The set of colorants may comprises a set of colored printing materials or colorants. Each colorant in the set of colorants may correspond to a different available color. In certain examples, the set of colorants comprise CMYK-based colorants, CcMmYK colorants with six or more inks including m (light magenta) and c (light cyan). In general, the set of colorants may comprise two or more different colors. The colorants may be inks, polymers, metals, ceramics, powder grains or biomaterials. In three-dimensional printing examples, a colorant may be a colored fluid that is applied to successive (two-dimensional) layers of a powder building material substrate.

The colorant color mapping may be implemented using a colorant look-up table (LUT). In the present examples, an LUT comprises a data structure where a set of input nodes in an input color space are mapped to a set of output nodes in an output space. A node-to-node mapping may form a row in the LUT. Values between the nodes of the LUT may be determined using interpolation, such as linear interpolation in the dimensions of the input color space and/or the output space. The colorant LUT thus comprises a set of colorant mapping parameters that are used to map the input color space to a colorant application color space. In the present case, the input nodes may comprise RGB or CMYK values, and the output nodes may comprise NPac vectors in a colorant NPac space (e.g. where each NP relates to a different output state for the set of colorants). The values within the LUT, e.g. the node-node mappings, may be based on factory testing and experimentation. For example, the printing system may print a series of test patches based on different NPac vector values. These may be measured using a colorimeter and/or spectrophotometer and the measurements then compared to known colorimetric and/or spectral measurements of RGB or CMYK outputs (e.g. test patches of different quantities of CMYK ink) to determine the mapping. Different methods of LUT construction are known in the art. The colorant LUT may be obtained from a data storage device of the printing system or received from a computing device communicatively coupled to the printing system.

At block 103, one or more treatment color mappings are obtained. The one or more treatment color mappings are associated with the set of treatments. Different treatment color mappings may be obtained for different treatments within the set of treatments. The set of treatments may comprise different treatment types such as pre-treatments, to be applied to the printing substrate prior to deposit of the set of colorants, and post-treatments, to be applied after the set of colorants (and any pre-treatment) is deposited on the printing substrate. Pre-treatments may include print fixers or print optimizers, e.g. fluids that aid the fixing of one or more of the set of colorants to the printing substrate and/or that improve a finish of the set of colorants via chemical means. In three-dimensional printing examples, a pre-treatment may comprise a form of binder or pre-binder that aids binding properties of powdered build material and/or that changes material properties of the powdered build material. Post-treatments may include overcoats, varnishes and spot glosses. Spot glosses may comprise a gloss that is selectively applied to a particular spot color, i.e. a color that has a specifically defined appearance such as a specified brand color. The set of treatments may also be inks, polymers, metals, ceramics, powder grains or biomaterials. In a two or three-dimensional biological printing case, the post treatments may comprise nutrients that are added to different colored biomaterials to allow for natural growth of the biomaterials.

The one or more treatment color mappings are associated with the different treatment types found within the set of treatments. For example, the one or more treatment color mappings may comprise a fixer color mapping and an overcoat color mapping. The one or more treatment color mappings may be implemented as corresponding treatment LUTs. In a similar manner to the colorant LUT, each treatment LUT may comprise a data structure where a set of input nodes in the input color space are mapped to a set of output nodes in an output space. However, in the present case, the output nodes may relate to application values for each treatment as opposed to colorant application values. Application values for each treatment may be defined as an NPac vector, but where the NPs comprise different output states for the treatment. For example, if a treatment has NPs relating to different numbers of drops—e.g. [N, D, DD, DDD]—then a treatment NPac vector may have elements relating to each of these treatment NPs. Different treatments may have different NPac vectors, for example different possible drop states and/or combinations of treatment printing materials. As for the colorant LUT, a node-to-node mapping may form a row in a treatment LUT. Values between the nodes of a treatment LUT may also be determined using interpolation. Each treatment LUT thus comprises a set of treatment mapping parameters that are used to map the input color space to a treatment application space. As the treatment color mappings are defined using independent data structures, the treatment color mappings may be applied to the image data independently of the colorant color mappings. The one or more treatment LUTs may be obtained in a similar manner to the colorant LUTs (although different methods may be used to obtain each LUT).

If there are a plurality of treatments, e.g. pre- and post-treatments or two different pre- or post-treatments, there may be a plurality of treatment LUTs. In this case, each treatment LUT may be independent and unique to its associated treatment type. For example, image data may be mapped to application values in respective treatment application spaces independently using the separate plurality of treatment LUTs.

As for the colorant LUTs, the one or more treatment LUTs may be obtained using known calibration and/or configuration methods. For example, the printing system may output test prints with test (e.g., known or pre-configured) deposits of a treatment and colorants on a printing substrate that may be measured using a colorimeter and/or spectrophotometer as for the colorants.

In one case, although the treatment and colorant color mappings may be applied independently to the input image data, they may be generated as a function of each other. For example, the colorant and treatment LUTs may be constructed through a common color characterization procedure. Each of the one or more treatment LUTs may also be generated as a function of the colorant LUT. In the case of there being a plurality of treatment LUTs, each of the treatment LUTs may be generated as a function of a different treatment LUT, as a function of a combination of one or more different treatment LUTs and/or as a function of the colorant LUT.

In one case, although the treatment and colorant color mappings may be applied independent of each other to the input image data, they may also be adjusted in response to an output of one of the other mappings. For example, an output of a treatment color mapping (e.g., a set of treatment NPac vectors) may be used to adjust a colorant color mapping (e.g., the function applied by a colorant LUT to output a set of colorant NPacs) and vice versa.

Returning to FIG. 1, at block 104, the colorant color mapping is used to map the image data to colorant application values within a colorant application space. This may comprise using a colorant LUT to map the image data defined by the input color space to a colorant application space, where output values in the colorant application space comprise colorant NPac vectors.

At block 105, the one or more treatment color mappings are used to map the image data to treatment application values within one or more treatment application spaces. This may comprise using each of one or more treatment LUTs to map the image data defined within the input color space to the associated treatment application space, where output values in the associated treatment application space comprise treatment NPac vectors. The application values in this case may be seen as a probability distribution of the associated treatment output states for each print resolution pixel. For example, an overcoat LUT may map the image data defined within the input color space to an overcoat NPac vector, which represents probability distributions of the overcoat output states or overcoat NPs for each print pixel. In the case of there being a plurality of treatment LUTs, treatment NPac vectors may be determined independently, i.e. the output application spaces may be independent.

At block 106 in FIG. 1, discrete print instructions to apply the set of colorants and set of treatments to a printing substrate are generated using the determined colorant application values and the determined treatment application values. In examples, the discrete printing instructions comprise a set of colorant instructions and one or more sets of treatment instructions. The set of colorant instructions may, for example, instruct a colorant print head of the printing system to deposit a colorant or combination of colorants at one or more print resolution pixels on the printing substrate. Similarly, the one or more sets of treatment instructions may instruct one or more treatment print heads of the printing system to deposit one or more associated treatments at one or more print resolution pixels on the printing substrate. For example, a set of fixing treatment instructions may instruct a fixing treatment print head to deposit a print fixer at a pixel on the printing substrate prior to deposit of the colorants, and a set of overcoat instructions may instruct an overcoat print head to deposit an overcoat at a pixel on the printing substrate (where the print resolution pixels may relate to the same or different areas of the printing substrate). In this case, the discrete printing instructions indicate to the colorant print head and the one or more treatment print heads of the printing system which colorants, combinations of colorants and/or treatments to deposit on the printing substrate, how to deposit them and at which point of the printing process they should be deposited in order to reproduce the image data on the printing surface. In the above example, the discrete printing instructions may indicate to the colorant print head, the fixing treatment print head and the overcoat print head that, at each pixel of the printing substrate, the fixer should be deposited first, the colorant and colorant combinations second, and the overcoat third. In the case that the colorants, fixer and overcoat are printing fluids, the discrete printing instructions may indicate a drop state to be used to deposit each printing fluid (e.g. instructions to control piezoelectric members within the respective print heads). In further examples, the discrete printing instructions may indicate a print mode such as a fast print mode or a slow print mode. In a fast print mode, the print heads of the printing system may deposit the printing materials at a faster rate than the slow print mode.

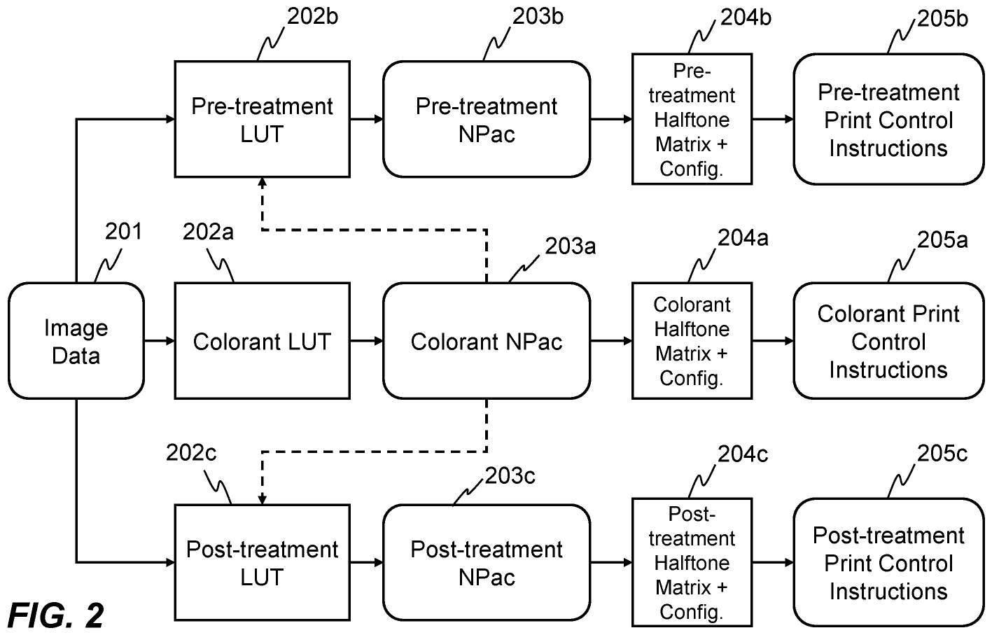

FIG. 2 is a schematic diagram illustrating the generation of print control instructions using an independent colorant LUT, pre-treatment LUT and post-treatment LUT according to examples. In examples, the printing system has printing materials comprising a set of colorants such as CMYK-based inks, a pre-treatment such as a fixer and a post-treatment such as an overcoat. Together, the pre-treatment and post-treatment form a set of treatments. The printing system stores in memory color mappings that are associated with each of the sets of printing materials, such that obtained image data 201 defined in an input color space can be represented in an application space associated with each of the sets of printing materials. In the present example, the printing system memory stores a colorant LUT 202a, a pre-treatment LUT 202b and a post-treatment LUT 202c. In the example of FIG. 2, each LUT is applied independently to the image data 201 and may be obtained and configured as described above. The image data 201 may be defined in a CMYK input color space.

As shown in FIG. 2, in one operation, the image data 201 is mapped to a set of colorant NPac vectors 203a using the colorant LUT 202a. For example, each color value for a pixel in the input color space may be mapped to a corresponding NPac vector in a colorant application space. In other cases, the spatial correspondence may not be one-to-one, e.g. color values for one or more pixels may be mapped to NPac vectors for one or more pixels. The colorant LUT may comprise output nodes that are defined as NPac vectors and input nodes that are defined within the input color space of the image data 201.

In FIG. 2, the image data 201 is also mapped to a set of pre-treatment NPac vectors 203b using pre-treatment LUT 202b and to a set of post-treatment NPac vectors 203c using post-treatment LUT 202c. The three mappings shown in FIG. 2 may be applied in parallel or in series. The three mappings may be applied in series if an adjustment is to be applied. The pre-treatment LUT 202b may comprise a plurality of input nodes within the input color space that are mapped to a plurality of output nodes within a pre-treatment NPac space, where pre-treatment NPac vectors in the pre-treatment NPac space represent pre-treatment application values in the form of a probability distribution of the pre-treatment at a pixel. Similarly, the post-treatment LUT 202b may comprise a plurality of input nodes within the input color space that are mapped to a plurality of output nodes within a post-treatment NPac space, where post-treatment NPac vectors represent post-treatment application values in the form of a probability distribution of the post-treatment at a pixel.

In certain examples, the colorant NPac vectors 203a may be used to determine one or more colorant parameters. In certain examples, these may be used to adjust one or more of the pre-treatment LUT 202b and the post-treatment LUT 202c as shown via the dashed arrows. The colorant parameters may comprise one or more of: the total amount of colorants to be used; the amount of each specific colorant to be used; the amount of each specific combination of colorants to be used; area coverage values for each colorant; and other NP colorant characteristics. These colorant parameters may be determined by processing the values within the colorant NPac vectors 203a (i.e. the colorant application values). In examples, the colorant LUT 202a may be the first LUT to be applied with the pre-treatment LUT 202b and post-treatment LUT 202c being adjusted based on the colorant LUT 202a. In one case, the pre-treatment LUT 202b and post-treatment LUT 202c may be generated based on the colorant parameters.

For example, the post-treatment LUT 202c may be associated with an overcoat. An overcoat may be used to ensure that there is an even coating of printing material deposited on the printing substrate. In this case, the post-treatment LUT 202c may be generated and/or adjusted as a function of the total amount of colorant as indicated by the colorant NPac vectors 203a. The function may ensure that larger amounts of overcoat are deposited for nodes in the LUT with lower amounts of colorants and that smaller amounts of overcoat are deposited for nodes in the LUT with higher amounts of colorants. This may ensure that there is an even coating of total printing material on the printing substrate.

In certain cases, the colorant parameters determined from the colorant NPac vectors 203a may be processed non-linearly to generate or adjust the pre-treatment LUT 202b and/or post treatment LUT 202c. For example, it may be desirable to have higher amounts of pre-treatment for lower tones, a constant amount of pre-treatment for mid-tones and lower amounts for darker tones. A sigmoid-like relationship between the colorants and pre-treatment may thus be used to generate or adjust the pre-treatment LUT 202b. In certain cases, the relationship between the colorants and treatments may vary for each colorant and combination of colorants.

In a further example, the LUTs may be generated to take into account special cases. For example, an overcoat LUT may be generated such that all CMYK inputs are mapped directly to an NPac vector indicating a constant amount of overcoat is to be applied to all colorants and combination of colorants; however, a special case may be defined for a CMYK input that indicates no colorant is to be applied (e.g. CMYK=[0, 0, 0, 0]). This special case may be mapped to a probability distribution (e.g. within the NPac vector) indicating a 0% likelihood of overcoat being deposited. This approach may be used to ensure that when no color ink is placed, no overcoat is placed either.

In certain examples, adjustment of one or more of the colorant LUT 202a, the pre-treatment LUT 202b and the post-treatment LUT 202c may be performed iteratively, e.g. based on one or more of the NPac vector outputs 203a, 203b, 203c from a previous iteration. For example, the colorant LUT 202a may be generated and/or adjusted as a function of one or more of the pre-treatment NPac vectors 203b and the post-treatment NPac vectors 203c; the pre-treatment LUT 202b may be generated and/or adjusted as a function of one or more of the colorant NPac vectors 203a and the post-treatment NPac vectors 203c; and the post-treatment LUT 202c may be generated and/or adjusted as a function of one or more of the pre-treatment NPac vectors 203b and the colorant NPac vectors 203a.

Returning to FIG. 2, in this example, halftoning is applied to each of the colorant NPac vectors 203a, the pre-treatment NPac vectors 203b and the post-treatment NPac vectors 203c. In certain cases, this may be performed following one or more iterative adjustments as discussed above. In FIG. 2, halftoning of the colorant NPac vectors 203a is performed using a colorant halftone matrix and colorant halftone configuration 204b. As discussed previously, halftoning may be applied to a colorant NPac vector 203a element by element based on an order set by a particular colorant halftone configuration. This order may indicate an order for the application of a colorant halftone matrix. The order may improve the image quality of the halftone output. For example, the colorant halftone configuration may indicate a light to dark order and the NP colorants for each NPac vector may be ordered light to dark when applying the colorant halftone matrix. The output of the halftoning process may comprise a particular output state to be applied by the printing system, e.g. one particular NP to be applied for each print resolution pixel. These may be used to output colorant print control instruction 205a. The halftoning process acts to effect a spatial distribution of the NPs according to the probability distributions specified in the colorant NPac vectors 203a. For example, the output colorant print control instruction 205a may comprise instructions for each output colorant print head (e.g. each of six CcMmYK print heads).

In the example of FIG. 2, halftoning is also be applied to the pre-treatment NPac vectors 203b and the post-treatment NPac vectors 203c. Similar to the colorant halftoning, pre-treatment halftoning is applied using a pre-treatment halftone matrix and pre-treatment halftone configuration 204b and post-treatment halftoning is applied using a post-treatment halftone matrix and post-treatment halftone configuration 204c. In certain examples, the colorant halftone matrix, pre-treatment halftone matrix and post-treatment halftone matrix all comprise the same halftone matrix. In other examples, the colorant halftone matrix, pre-treatment halftone matrix and post-treatment halftone matrix each have a unique halftone matrix. Halftoning may be applied to the pre-treatment NPac vectors 203b and the post-treatment NPac vectors 203c using the same halftoning process as described for the colorants. For example, halftoning may be applied to the pre-treatment NPac vectors 203b by selecting pre-treatment NPs within a pre-treatment NPac vector in an order specified by a particular pre-treatment halftone configuration. These may then be processed in this order using the pre-treatment halftone matrix.

When the halftone matrix is the same for each of the printing materials, the selection of the colorant halftone configuration, pre-treatment halftone configuration and post-treatment halftone configuration for the same node of image data has an effect on the generation of each of the corresponding halftone output values. When applying halftoning to each of the NPac vectors, the same colorant halftone configuration and treatment halftone configurations may be chosen. For example, a color value for a pixel of image data (e.g. an RGB or CMYK value for a pixel), when mapped to the colorant application space and pre-treatment application space using the colorant LUT and pre-treatment LUT respectively, may result in a colorant NPac vector and a pre-treatment NPac vector for the same pixel. In a case where a colorant NPac vector has a probability distribution of 50% Blank NP (“w”) and 50% Cyan NP (e.g. [w:0.5, C:0.5]—other NPs omitted as they are 0), and a pre-treatment NPac vector has a probability distribution of 80% Blank NP and 20% Pre-treatment NP (e.g. [w:0.8, P:0.2]), then it may be desired that the evaluation order for the colorant NPs and the pre-treatment NPs order is light to dark. In this case, the colorant halftone configuration and the pre-treatment halftone configuration indicate a shared or common order and in both cases the Blank NP is evaluated first. This means that instructions for the deposit of Cyan and Pre-treatment will coincide, such that pre-treatment is applied when Cyan is to be applied, as opposed to being applied to a blank printing substrate where no Cyan is to be applied. By using a similarly configured order of NP evaluation, in this case, all the pre-treatment deposits will coincide with Cyan deposits, while in 30% of the cases, Cyan depositions will not coincide with pre-treatment depositions (since in the NPac vectors P is 20% and C is 50%). Using a shared or common order of halftone application (in effect performing a sampling of the NPac vectors such that the evaluation of similar NPs is performed in a similar order), e.g. as implemented by using shared or common halftone configuration data, may allow for the improved control of colorant and treatment deposits despite independent application of colorant and treatment LUTs. For example, if the pre-treatment is a fixer it is beneficial for the fixer to be deposited wherever colorant is to be deposited on the printing substrate, so it can act to fix the colorant. The halftone configurations and corresponding LUTs can be built to ensure that the produced halftone application values produce this effect when the colorant and pre-treatments are deposited on the printer substrate.

It may also be beneficial for particular overcoat coat states to coincide, or avoid coinciding, with particular colorant states. For example, it may be preferred to avoid a combination of heavy overprint colorant NPs with large amounts of overcoat (e.g. DDD output states), as this may overload a printing substrate. In this case, a color value for a pixel of image data may be mapped to a colorant NPac vector and an overcoat NPac vector. The same halftone matrix may be used to apply halftoning to each NPac vector. When applying halftoning to the colorant NPac vector, the colorant halftone configuration may indicate an NP evaluation order that is light to dark. The combination of the colorant halftone configuration and the halftone matrix may be configured such that lighter tones have a low likelihood of colorant being deposited (and therefore a high likelihood of being blank) and darker tones have a high likelihood of colorant being deposited. In the present case, when applying halftoning to the overcoat NPac vector, the overcoat halftone configuration can be configured to evaluate the overcoat NPs in an opposite manner, e.g. from dark NPs to light NPs (e.g. where “light” and “dark” may correspond to different amounts of overcoat). In this case, the same halftone matrix may be used for the overcoat as for the colorants, but the deposit likelihoods are reversed, e.g. for lighter tones, the overcoat treatment has a high likelihood of deposition and for darker tones, the overcoat has a low likelihood of deposition. This results in the deposition of the overcoat being more likely to coincide with a lighter colorant or lack of colorant and less likely to coincide with the heavy deposition of colorant or darker colorants. This may then ensure an even deposition of printing materials across the printing substrate and/or avoid changes in color appearance due to the darkening of already dark colorants with overcoat.

In FIG. 2, the halftoning of the colorant NPac vectors 203a, the pre-treatment NPac vectors 203b and the post-treatment NPac vectors 203c results in a set of colorant print control instructions 205a, a set of pre-treatment print control instructions 205b and a set of post-treatment print control instructions 205c respectively. The colorant print control instructions 205a, pre-treatment print control instructions 205b and post-treatment print control instructions 205c each comprise a set of discrete print control instructions. The colorant print control instructions 205a may comprise a set of instructions for a set of print heads which are used to apply the set of colorants to the printing substrate. The set of print heads may comprise four, six or eight print heads with each print head being used for a different color of a set of CMYK-based colorants. The set of instructions may provide an ordered list of colorants and combinations of colorants to be deposited at pixels of the printing substrate. The pre-treatment print control instructions 205b may comprise a set of instructions for a print head to apply a pre-treatment to pixels on the printing substrate. The post-treatment print control instructions 205b may comprise a set of instructions for a print head to apply a post-treatment to pixels on the printing substrate. The colorant print control instructions 205a, pre-treatment print control instructions 205b and post-treatment print control instructions 205c may be combined to form a set of instructions comprising an ordered list of colorants, pre-treatments and post-treatments to be deposited at pixels on the printing substrate. The order of the list of printing materials indicates when they are to be deposited on the printing substrate at each pixel. The instructions are discrete as they reflect the limited number of output states of the printing system.

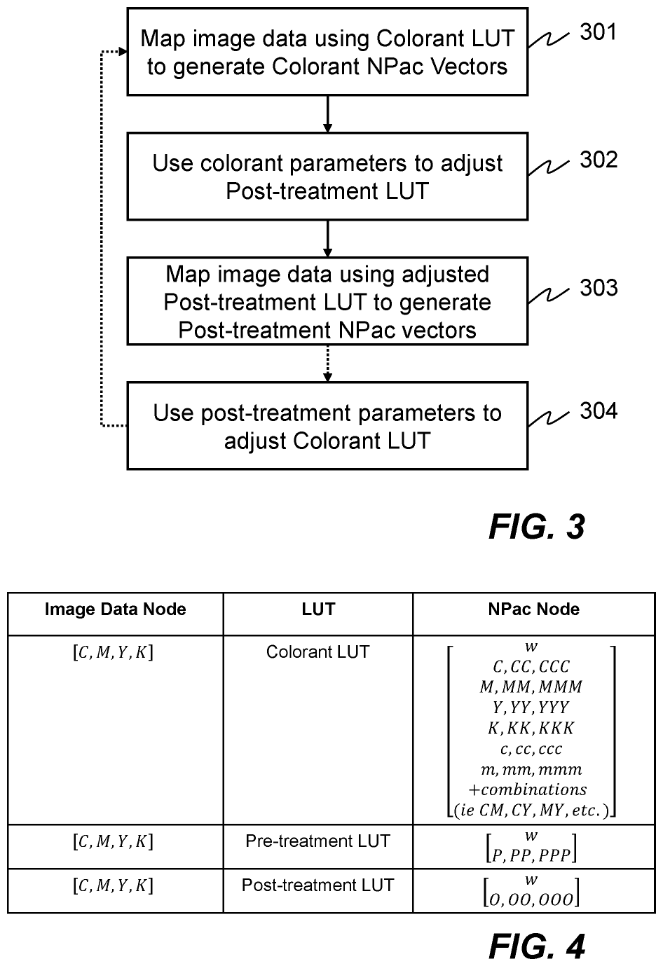

FIG. 3 is a flow chart illustrating a method of adjusting one or more of a colorant LUT and a post-treatment LUT according to examples. The method may be used in association with the method of FIG. 1 and/or the printing system of FIG. 2. For ease of explanation, an example with colorants and post-treatments is described, however, the same approach may be applied to two or more of a set of: a colorant LUT, a pre-treatment LUT and a post-treatment LUT.

At block 301, the colorant LUT is used to map image data to a set of colorant NPac vectors. This may be performed as described with reference to the colorant LUT 202a of FIG. 2. The set of colorant NPac vectors are then used to determine a set of colorant parameters. These may comprise colorant parameters as described above and including one or more of: the total amount of colorants to be used; the amount of each specific colorant to be used; the amount of each specific combination of colorants to be used; area coverage values for each colorant; and other NP colorant characteristics as indicated by colorant application values.

At block 302, the colorant parameters are used to adjust the post-treatment LUT. This may comprise adjusting the values within the post-treatment LUT 202c in FIG. 2, e.g. by adjusting the mapping parameters of the post-treatment LUT based on values of one or more colorant NPac vectors. The mapping parameters of the post-treatment LUT may be adjusted based on a function of the colorant application values. For example, the amount of post-treatment may be modified based on a total amount of colorant indicated by the set of colorant NPac vectors. The function can be linear or non-linear and include special cases as discussed previously.

At block 303, the adjusted post-treatment LUT is used to map the image data to generate a set of post-treatment NPac vectors. As the post-treatment LUT is adjusted based on the colorant NPac vectors, the set of post-treatment NPac vectors may differ from a set of post-treatment NPac vectors output by a non-adjusted post-treatment LUT. In the present example, the set of post-treatment NPac vectors are used to determine a set of post-treatment parameters. These may comprise the set of post-treatment NPac vectors themselves or an aggregate function of this data, such as: the total amount of post-treatment to be used; the specific combination of post-treatment to be used; area coverage values for the post-treatment; and other NP post-treatment characteristics as indicated by post-treatment application values. The post-treatment parameters may thus be determined in a similar manner to the colorant treatment parameters; however, they may comprise a different set of metrics in certain cases.

An iterative process of adjusting the color treatment LUT based on the adjusted post-treatment LUT is employed at block 304 of FIG. 3. At block 304, the post-treatment parameters are used to adjust the colorant LUT and then at least block 301 may be repeated to update the colorant NPac vectors. The adjustment at block 304 may be performed in a similar manner to block 302. Adjusting the colorant LUT based on the adjusted post-treatment LUT may improve the overall quality of the print output, e.g. by changing the color mapping for the colorants based on an initial set of colorant and post-treatment NPac vectors. For example, if the post-treatment NPac vectors indicate a high level of post-treatment usage, when the block 301 is iterated based on an adjusted colorant LUT, darker tones may be selected at the mapping of block 301, thus allowing a possible reduction in post-treatment at the subsequent mapping of block 303.

In certain examples, a printing system with a set of colorants and a post-treatment may comprise an imaging interface. The printing system may be configured to produce a print output by depositing the set of colorants and post-treatment on a printing substrate based on a set of generated color print control instructions and post-treatment control instructions, e.g. as generated based on the colorant application values and the post-treatment application values produced by mapping the image data using the adjusted colorant LUT and adjusted post-treatment LUT respectively. In this case, the quality of the print output may be inspected using the image interface of the printing system. The printing system may use the quality of the print to determine if the iteration process is to be terminated or continued further.

In certain examples, the method of FIG. 3 may be applied to a pre-treatment LUT and a post-treatment LUT. The pre-treatment LUT may be adjusted based on a function of the post treatment application values. In further examples, the method of FIG. 3 may be applied to a colorant LUT, a post-treatment LUT and a pre-treatment LUT where the iterative process incorporates adjusting one or more of the post-treatment LUT and the colorant LUT based on NPac vectors.

In certain examples, one or more of a pre-treatment LUT, a colorant LUT and a post-treatment LUT may be adjusted as a function of other print parameters to improve a quality of a print output, e.g. instead of, or in addition to, the adjustment described above. For example, one or more of the LUTs may be adjusted for different print modes of the printing system. In this case, a set of print modes may comprise a fast print mode and slow print mode. The printing system when operating in the fast print mode may deposit printing materials at a faster rate with less printing material being used to complete the print. The fast print mode results in a low-quality print which is quickly produced. The printing system when operating in the slow print mode may deposit printing materials at a slower rate with more printing material being used to complete the print. The slow print mode may result in a high-quality print which takes a long time to produce. When these print modes are used, they may be indicated in a set of print parameters and one or more of the pre-treatment LUT, the colorant LUT and the post-treatment LUT may be iteratively adjusted using these print parameters in a method similar to that shown in FIG. 3 to generate application values and, in turn, discrete print control instructions optimized for each of the print modes. In one case, instead of adjusting a pre-existing set of LUTs, different colorant and treatment mappings may be built for different print modes, where the different mappings may be applied independently as set out above. A similar approach may also be applied to adjust LUT generation and/or adjustment based on printing substrate (e.g. textile vs paper vs cardboard).

FIG. 4 is a table illustrating the form of nodes for a set of example LUTs. The first row of the table shows the column headings. The first column of the table demonstrates the general form of an input data node that may form part of an interface for image data. In FIG. 4, the input data node is defined in a contone CMYK input color space, and so each input data node comprises a n-bit vector of CMYK values (e.g. four values between 0 and 255 in an 8-bit case). The third column of the table demonstrates the general form of an output data in an application space where different printing materials are to be applied. The second column of the table demonstrates the type of color mapping used to map the first column to the third column. As such, in FIG. 4, the second row of the table demonstrates how an input data node within CMYK input color space may be mapped to a colorant NPac using a colorant LUT; the third row of the table demonstrates how an input node within CMYK input color space may be mapped to a pre-treatment NPac using a pre-treatment LUT; and the fourth row of the table demonstrates how an input data node within the CMYK input color space may be mapped to a post-treatment NPac using a post-treatment LUT.

As demonstrated by the first column of the table, the input data nodes for the CMYK input color space are the same for each of the color mapping types. There may be a plurality of input data nodes representing points within the input color space. A full mapping from 8-bit CMYK color space would have 255⁴ input data nodes, and so a reduced number of nodes that are distributed across the input color space may be provided (e.g. 17³ for RGB or 9⁴ for CMYK), where interpolation is used between nodes. The node of the CMYK input color space in Figure comprises four variables where each variable represents a color of the input color space, C for Cyan, M for Magenta and K for BlacK.

FIG. 4 shows an example where a printing system has a set of colorants, a pre-treatment and a post-treatment. In this example, the set of colorants, pre-treatment and post-treatment comprise printing fluids. Dimensions within the colorant application space, the post-treatment application space and the pre-treatment application space are thus based on controllable deposit amounts of the printing fluids. For example, the printing fluids may be deposited in a number of drops.

The colorant LUT maps each input data node to a corresponding output data node in the colorant NPac space, where each output data node comprises a colorant NPac vector. A six ink CMYKcm NPac vector is shown in FIG. 4, where c represents a light cyan ink and m represents a light magenta ink, but a four or eight ink CMYK based NPac vector may be used. Values in the colorant NPac vector represent the likelihood of colorant fluids being deposited on the printing substrate in drop states, where in this example, up to three drops of ink may be deposited at each print resolution pixel. This may represent a three-pass print head. For example, C represents a single drop of Cyan colorant fluid, CC represents two drops of Cyan colorant fluid and CCC represents three drops of Cyan colorant fluid. The likelihood of no colorant fluid being deposited is indicated by the blank (w) variable. The likelihood of a combination of the colorant fluids being deposited at the same time can be represented by listing the variables together as is demonstrated in the second row of the third column of FIG. 4 by “+combinations”. For example, CM indicates the likelihood of the combination of cyan and magenta colorant fluid being deposited on the printer substrate. In certain cases, combinations may be applied by overprinting, e.g. the combination CMm may be generated by printing C, M, and m drops within an area for a single print resolution pixel in three passes. Although not listed in the table, the colorant application values may comprise any combination of colorant fluid variables with any drop state (e.g. up to three drops in total).

In the third row of FIG. 4, an input data node is mapped to an output data node within a pre-treatment NPac space using the pre-treatment LUT. The output data node here is represented by a pre-treatment NPac vector, where values for elements in the vector represent the likelihood of different amounts of pre-treatment fluid being deposited on the printing substrate. In this example, the pre-treatment fluid has three drop states, e.g. representing that up to three drops of pre-treatment fluid (“P”) may be applied to each print resolution pixel. The likelihood of no pre-treatment fluid being deposited is indicated by the blank (“w”) variable.

In the fourth row of FIG. 4, an input data node is mapped to an output data node within a post-treatment NPac space using the post-treatment LUT. In examples, the post-treatment fluid is an overcoat fluid (“0”). The output data node here is represented by a post-treatment NPac vector, where values for elements represent the likelihood of different states or amounts of the overcoat fluid being deposited on the printing substrate. In the present example, up to three drops of overcoat may be deposited, with the likelihood of no overcoat fluid being indicated by the blank (“w”) variable.

Although, the pre-treatment and post-treatment LUTs are defined separately above, in certain examples they may be combined in a single LUT, e.g. with NPac vectors having elements representing different combinations of pre and/or post-treatments. A similar approach may also be used to construct LUTs for a plurality of pre-treatments and/or a plurality of post-treatments, wherein different treatments may be represented as per the different colorants in the colorant NPac space. Using combined LUTs may allow for explicit control of interactions between combined printing materials.

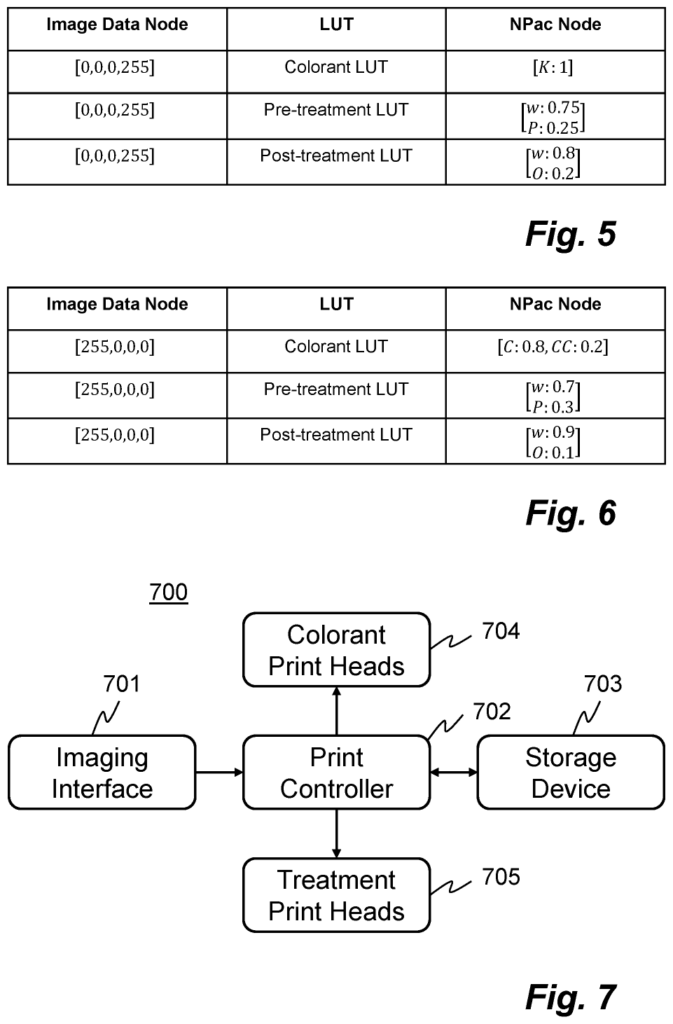

Based, on the LUT configurations of FIG. 4, FIGS. 5 and 6 show a set of example input-output node pairs. FIG. 5 shows a color mapping for an example “Black” input data node that is represented by the CMYK value [0, 0, 0, 255] and FIG. 6 shows a color mapping for an example “Cyan” input data node that is represented by the CMYK value [255, 0, 0, 0]. Similar to FIG. 4, the rows of FIGS. 5 and 6 respectively show examples of a colorant LUT, a pre-treatment LUT and a post-treatment LUT. FIGS. 4, 5 and 6 are provided for example and other color mappings and/or LUT formats are possible depending on the implementation.

Using the colorant LUT, the “Black” input data node is mapped to a colorant NPac vector of [K:1] (other elements being omitted as they are 0). This means that, for pixels of image data have a value that matches the “Black” input data node, there is a 100% likelihood of one drop of black colorant fluid being deposited on the printing substrate for the node of the input color space. Using the pre-treatment LUT, the same “Black” input data node is mapped to a pre-treatment NPac vector of [w:0.75, P:0.25]. This means that, for pixels of image data have a value that matches the “Black” input data node, there is a 75% likelihood of no pre-treatment fluid being deposited and a 25% likelihood of pre-treatment fluid being deposited in a single drop on the printing substrate. Using the post-treatment LUT, the same “Black” input data node is mapped to a post-treatment NPac vector of [w:0.8, O:0.2], which means there is a 80% likelihood of no overcoat fluid being deposited and a 20% likelihood of overcoat fluid being deposited in a single drop on the printer substrate.

A similar mapping process is shown for a “Cyan” input data node in FIG. 6. Using the colorant LUT, the “Cyan” input data node is mapped to a colorant NPac vector of [C:0.8, CC:0.2] (other elements being omitted as they are 0). This means that, for pixels of image data have a value that matches the “Black” input data node, there is an 80% likelihood of Cyan colorant fluid being deposited in a single drop and a 20% likelihood of Cyan colorant fluid being deposited in a double drop on the printing substrate. Using the pre-treatment LUT, the “Cyan” input data node is mapped to a pre-treatment NPac vector of [w:0.7, P:0.3], which means there is a 70% likelihood of no pre-treatment fluid being deposited and a 30% likelihood of pre-treatment fluid being deposited in a single drop on the printing substrate. Lastly, using the post-treatment LUT, the “Cyan” input data node is mapped to a post-treatment NPac vector of [w:0.9, P:0.1], which means there is a 90% likelihood of no overcoat fluid being deposited and a 10% likelihood of overcoat fluid being deposited in a single drop on the printing substrate.

The tables of FIG. 5 and FIG. 6 indicate the increased level of control over the printing materials that is given by the use of independent LUTs. For a black node of input color space, a higher amount of overcoat and a lower amount of pre-treatment are defined, while for a cyan node of input color space a lower amount of overcoat and a higher amount of pre-treatment are used.

Certain variations are also possible. In one example, the colorant color mapping may comprise a plurality of colorant color maps. In this case, each colorant color map in the plurality of colorant color maps may be used to map the image data to colorant application values within a respective colorant application space, wherein the dimensions within the colorant application space represent applications of a subset of the set of colorants to a printable substrate. For example, a method of generating discrete print control instructions may comprise of the use of two LUTs for colorants, a first colorant LUT to map input image data to CMYK colorant NPs (i.e. the CMYK inks in a printer) and a second LUT to map input image data to cm NPs (i.e. the cm inks in a printer).

In a further example, a treatment color mapping may comprise combinations of treatments and colorants. The colorants may comprise a subset of a set of available colorants, such as the cm colorants as in the above example. In this case, the treatment color map may be used to map the image data to treatment application values within a treatment application space, wherein the dimensions within the treatment application space represent different applications of treatments and colorants from the set of treatments and a subset of the set of colorants respectively. For example, a method of generating discrete print control instructions may comprise of the use of two LUTs, a colorant LUT to map input image data to CMYK colorant NPs and a treatment LUT to map input image data to cm and treatment NPs.

In another example, the colorant color mapping and the treatment color mapping may be combined using a joint color map. In this case, the joint color map may be used to map the image data to colorant and treatment application values within a combined application space, wherein the dimensions within the combined application space represent different applications of colorants and treatments from the set of colorants and the set of treatments respectively. For example, a method of generating discrete print control instructions may comprise of the use of one LUT, a colorant LUT to map input image data to CMYKcm colorant NPs and treatment NPs.

In an additional example, a treatment color mapping comprises color mappings for both post-treatments and pre-treatments. For example, a single treatment color map may be used to map the image data to treatment application values within a treatment application space wherein the dimensions within the treatment application space represent different applications of the post-treatments and pre-treatments. For example, a method of generating discrete print control instructions may comprise of the use of a single treatment LUT to map input image data to post-treatment NPs and pre-treatment NPs. In this case the output NPac vector may comprise different combinations of the post-treatment and pre-treatment in different drop states i.e. [w, P, O, PO, PP, OO, POO, PPO, PPP, OPP, OOP, OOO, etc.].

FIG. 7 is a schematic diagram of a printing system according to examples. The printing system 700 may be used to apply any of the previous examples. The printing system 700 comprises a first set of print heads to apply a set of colorants to a printing substrate in the form of colorant print heads 704. The colorant print heads are arranged to deposit CMYK colorants. The printing system 700 also comprises a second set of print heads to apply a set of treatments to a printing substrate in the form of treatment print heads 705. The treatment print heads may comprise separate or joint pre- and post-treatment print heads that are arranged to respectively deposit a pre-treatment and a post-treatment. The printing system 700 comprises an imaging interface 701 to obtain image data defined within an input color space. The imaging interface 701 may receive data to be printed, e.g. from a print driver of a local or remote computing device and/or from a digital front end of a printing press. The image data obtained via the imaging interface is defined within an input color space, which may be a digital contone RGB or CMYK input color space as described above.

The printing system 700 also comprises a storage device 703 to store a colorant color mapping and one or more treatment color mappings. In this case, output dimensions for the colorant color mapping represent different applications of the set of colorants and output dimensions for each treatment color mapping represent different applications of treatments from the set of treatments. The colorant color mapping may be implemented as a colorant LUT, e.g. according to the example format of FIGS. 4 to 6. The one or more treatment color mappings may comprise a pre-treatment color mapping and post-treatment color mapping. The pre-treatment color mapping and post-treatment color mapping may be implemented as a pre-treatment LUT and post-treatment LUT respectively. Each of the LUTs may have output dimensions which represent different drop states of the associated printing material of the LUT, e.g. as described with respect to the examples of FIGS. 4 to 6.

The printing system 700 comprises a print controller 702 which contains a processor configured to carry out the steps of the flow diagram in FIG. 1. The processor may comprise an embedded processor for a printing device or a central processing unit (CPU) of a computing device that is communicatively coupled to the colorant and treatment print heads. The storage device 703 may comprise a non-transitory computer-readable storage medium that contains a set of computer-readable instructions that, when executed by the processor of the print controller 702, causes the processor to carry out the method discussed steps of the flow diagram in FIG. 1. The storage device may be standard storage circuitry such as volatile and/or non-volatile storage, including random-access memory (RAM), hard disks and/or solid-state storage devices.

Certain examples described herein provide the ability to control print properties, including color, coalescence, durability, in a printing system. They are particularly suited to complex printing system configurations, where color inks are combined with additional fluids to modulate ink-ink and ink-substrate interactions. In certain examples, color inks and extra fluids may be controlled independently, while being able to co-optimize choices about both. Their use may also be optimized as a function of their use or other quantities. Certain examples may allow for more direct and targeted use of printing materials in response to their interaction characteristics, enabling better color, coalescence, durability performance.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method comprising:
obtaining image data defined within an input color space;
obtaining a colorant color mapping associated with a set of colorants;
obtaining one or more treatment color mappings associated with a set of treatments;
using the colorant color mapping to map the image data to colorant application values within a colorant application space, wherein dimensions within the colorant application space represent different applications of the set of colorants to a printing substrate;
using the one or more treatment color mappings to map the image data to treatment application values within one or more treatment application spaces, wherein dimensions within each treatment application space represent different applications of treatments from the set of treatments to the printing substrate; and
generating discrete print control instructions to apply the set of colorants and the set of treatments to the printing substrate using the determined colorant application values and the determined treatment application values.

2. The method of claim 1, wherein the set of treatments comprise a pre-treatment to be applied before the application of the colorants and a post-treatment to be applied after the application of the colorants.

3. The method of claim 2, wherein the one or more treatment color mappings comprise a pre-treatment color mapping for the pre-treatment and a post-treatment color mapping for the post-treatment, wherein output dimensions for the pre-treatment color mapping represent different applications of the pre-treatment to the printing substrate and output dimensions for the post-treatment color mapping represent different applications of the post-treatment to the printing substrate.

4. The method of claim 1, wherein generating discrete print control instructions comprises halftoning the color application values and treatment application values.

5. The method of claim 4, comprising:
obtaining halftoning data;
applying halftoning to the colorant application values within the colorant application space using the obtained halftoning data; and
applying halftoning to the treatment application values within at least one of the one or more treatment application spaces using the obtained halftoning data.

6. The method of claim 5, comprising:
applying halftoning to the colorant application values within the colorant application space using a first halftoning configuration of the obtained halftoning data; and
applying halftoning to the treatment application values within at least one of the one or more treatment application spaces using a second halftoning configuration of the obtained halftoning data,
wherein the second halftoning configuration differs from the first halftoning configuration.

7. The method of claim 1, comprising:
adjusting the one or more treatment color mappings based on the colorant application values output from the colorant color mapping; and
mapping the image data using the one or more adjusted treatment color mappings to generate an adjusted set of treatment application values for use in the generating of the discrete print control instructions.

8. The method of claim 7, comprising:
adjusting the colorant color mapping based on the treatment application values output from one or more treatment color mappings; and
mapping the image data using the adjusted colorant color mappings to generate an adjusted set of colorant application values for use in the generating of the discrete print control instructions.

9. The method of claim 8, comprises:
adjusting a second treatment color mapping based on the treatment color application values output from a first treatment color mapping; and
mapping the image data using the adjusted second treatment color mapping to generate an adjusted set of second treatment application values for use in the generating of the discrete print control instructions.

10. The method of claim 7, wherein the adjusting is performed as a function of one or more of:
a total amount of printing material to be used as indicated by the colorant application values;
an amount of one or more specific printing materials to be used as indicated by the colorant application values;
an amount of one or more specific combinations of printing materials to be used as indicated by the colorant application values; and
area coverage values as indicated by the colorant application values.

11. The method of claim 1, wherein the input color space is a device-dependent color space.

12. The method of claim 1, wherein the colorant application values and treatment application values are Neugebauer Primary area coverage—NPac—values provided as an NPac vector, and wherein the discrete print control instructions instruct different Neugebauer Primaries to be output during printing.

13. The method of claim 1, wherein the set of colorants and the set of treatments comprise printing fluids, and dimensions within the colorant application space and the dimensions within each treatment application space are based on controllable deposit amounts of the printing fluids.

14. A printing system comprising:
a first set of print heads to apply a set of colorants to a printing substrate;
a second set of print heads to apply a set of treatments to a printing substrate;
an imaging interface to obtain image data defined within an input color space;
a storage device to store a colorant color mapping and one or more treatment color mappings, wherein output dimensions for the colorant color mapping represent different applications of the set of colorants and output dimensions for each treatment color mapping represent different applications of treatments from the set of treatments; and
a print controller comprising a processor configured to:
map the image data to colorant application values using the colorant color mapping;
map the image data to treatment application values using the one or more treatment color mappings; and
generate discrete print control instructions for the first and second print heads using the colorant application values and the treatment application values.

15. A non-transitory computer-readable storage medium comprising a set of computer-readable instructions that, when executed by a processor, cause the processor to:
obtain image data defined within an input color space;
obtain a colorant color mapping associated with a set of colorants;
obtain one or more treatment color mappings associated with a set of treatments;
map the image data to colorant application values within a colorant application space using the colorant color mapping, wherein dimensions within the colorant application space represent different applications of the set of colorants to a printing substrate;
map the image data to treatment application values within one or more treatment application spaces using the one or more treatment color mappings, wherein dimensions within each treatment application space represent different applications of treatments from the set of treatments to the printing substrate; and
generate discrete print control instructions to apply the set of colorants and the set of treatments to the printing substrate using the colorant application values and the treatment application values.
